(19) United States
(12) Patent Application Publication
(10) Pub. No.: US 2010/0020351 A1
(43) Pub. Date: Jan. 28, 2010

(54) IMAGE PROCESSING APPARATUS, IMAGE PROCESSING METHOD, AND COMPUTER READABLE MEDIUM

(75) Inventor: Ryuichi ISHIZUKA, Kawasaki-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/372,269

(22) Filed: Feb. 17, 2009

(30) Foreign Application Priority Data
Jul. 25, 2008 (JP) 2008-192375

(51) Int. Cl. G06F 3/12; G06K 9/68

(52) U.S. Cl. 358/1.15; 382/218

(57) ABSTRACT

An image processing apparatus includes: a plurality of different conversion processing systems that converts page description language data into raster image data; a conversion control unit that controls each of the different conversion processing systems to convert page description language data to be inspected into raster image data; and a difference information outputting unit that outputs difference information in a case where there is a difference among the raster image data as conversion results obtained by the conversion processing systems.

### CROSS-REFERENCE TO RELATED APPLICATIONS

This application is based on and claims priority under 35 U.S.C. 119 from Japanese Patent Application No. 2008-192375 filed Jul. 25, 2008.

### BACKGROUND

1. Technical Field

The present invention relates to an image processing apparatus, an image processing method, and a computer readable medium.

2. Related Art

It has become popular to describe an image by using the page description language such as PostScript (trade mark) (hereinafter abbreviated as PS) or PDF and use the image thus described by such the language for printing or display. As a software such as an interpreter (also called as RIP which is abbreviation of Raster Image Processor) which interprets page description language data (data described by the page description language) and generates raster image data, there are various kinds of software treating the same page description language and also there are various versions as to the same kind of the software.

Further, for example, as a method of printing PDF data, there are not only a method of directly converting the PDF data into a raster image by using the RIP for PDF but also a method of once converting the PDF data into PS data by using a conversion software and then converting the PS data into a rater image by using the RIP for PS. In this manner, there is a case that the conversion of page description language data into a raster image is performed by the combination of plural software.

In this manner, there are various types as the conversion processing system (that is, a system for realizing the conversion by a single conversion program or the combination of plural programs) for converting data described by the same page description language into a raster image. When the conversion processing system differs, there may arise a case that raster images generated by the same page description language differ slightly therebetween due to the difference in the mounting method of specification or the difference in the treatment of a complicated processing portion.

A person who prepared page description language data generates a raster image from the page description language data by using the conversion processing system of own environment (that is, a computer system) and confirms the appearance of the raster image. However, in the case where the page description language data prepared by one person is transferred to another person, if the conversion processing system used by the another person differs from the conversion processing system of the one person, there arises a case that a raster image expected by the one person can not be outputted. For example, such a problem may arise in the case where page description language data prepared by a publishing company is transferred to and printed by a printing company.

### SUMMARY

According to an aspect of the present invention, an image processing apparatus includes: a conversion control unit that controls each of a plurality of different conversion processing systems, which converts page description language data into raster image data, to convert page description language data to be inspected into raster image data; and a difference information outputting unit that outputs difference information in a case where there is a difference among the raster image data as conversion results obtained by the conversion processing systems.

### BRIEF DESCRIPTION OF THE DRAWINGS

Exemplary embodiment of the present invention will be described in detail based on the following figures, wherein:

FIG. 1 is a block diagram showing an example of the configuration of the image processing apparatus according to an embodiment;

FIG. 2 is a flowchart for showing an example of the procedure of a threshold value setting procedure for inspecting page description language data;

FIG. 3 is a flowchart for showing an example of the processing procedure in a difference detection part;

FIG. 4 is a flowchart for showing an example of the color comparison processing in the processing procedure of the difference detection part;

FIG. 5 is a flowchart for showing an example of the figure comparison processing in the processing procedure of the difference detection part;

FIG. 6 is a diagram for explaining a start-point/end-point list;

FIG. 7 is a flowchart for showing an example of the start-point/end-point comparison processing in the figure comparison processing;

FIG. 8 is a diagram showing an example where the image processing apparatus (inspection apparatus) according to the embodiment is applied to a user environment; and

FIG. 9 is a diagram showing an example of the hardware configuration of a computer.

### DETAILED DESCRIPTION

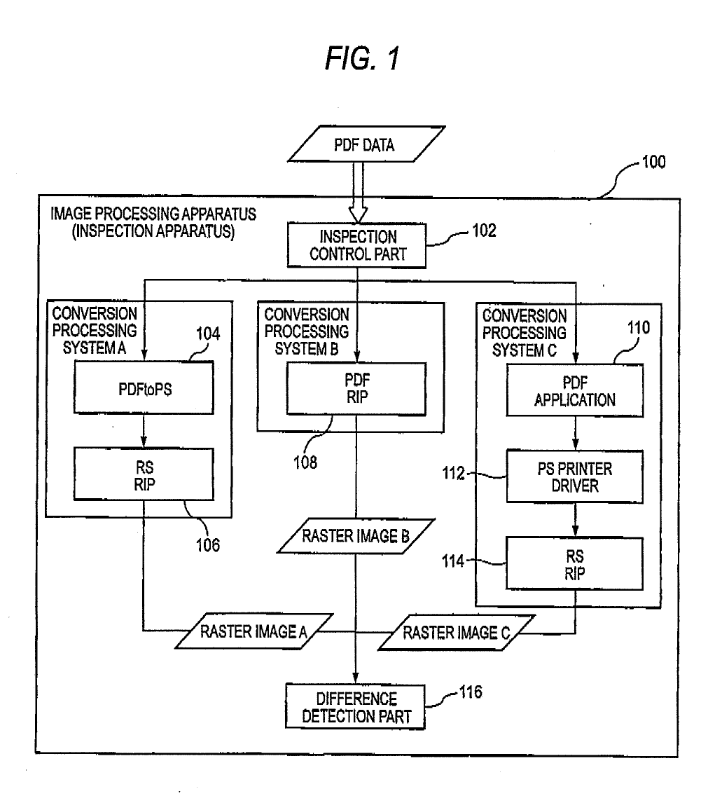

An example of the configuration of the image processing apparatus according to an embodiment will be explained with reference to FIG. 1. The image processing apparatus (inspection apparatus) 100 of FIG. 1 is an inspection apparatus for inspecting PDF data. Although the explanation is made as to PDF as one example the page description language, it will be easily understood for those skilled in the art that the embodiment can also be applied to page description language other than PDF.

The image processing apparatus 100 mounts all conversion processing systems which assumed to be used by users of various kinds of PDF data, as the conversion processing system for converting PDF data into a raster image. However, FIG. 1 shows only three conversion processing systems A, B, C as representative examples in order to simplify the drawing.

The conversion processing system A is configured by a PDF to PS conversion part 104 for converting PDF data into PS data and a PS RIP 106 for converting the PS data into a raster image. The conversion processing system B is configured by a PDF RIP 108 for converting PDF data into a raster image. The conversion processing system C is configured by a PDF application 110, a PS printer driver 112 and a PS RIP 114. The PDF application 110 is application software treating PDF data. PDF application 110 is Adobe (trade mark) Acrobat (trade mark), Adobe (trade mark) Reader (trade mark) of Adobe Systems, for example. The PS printer driver 112 is called from the PDF application 110 and converts PDF data supplied from the PS printer driver 112 into PS data.

Each of the PDF to PS conversion part 104, PS RIP 106, PDF RIP 108, PDF application 110, PS printer driver 112 and PS RIP 114 is mounted as a program system formed by a single program or plural programs (hereinafter collectively referred to “program”). The aforesaid functions are attained by executing these programs in the processor of the image processing apparatus 100.

The constituent elements within the conversion processing systems A, B and C may be made common. For example, the PS RIP 106 and the PS RIP 114 may be mounted as the same programs. In this case, the processor of the image processing apparatus 100 executes the same PS RIP program not only in the case of executing the processing of the PS RIP 106 in the processing of the conversion processing system A but also in the case of executing the processing of the PS RIP 114 in the processing of the conversion processing system C.

The image processing apparatus 100 receives PDF data from the outside and is instructed to execute the inspection. Then, the inspection control part 102 inputs the PDF data into each of the conversion processing systems A, B and C within the image processing apparatus 100 to thereby convert into raster images. The conversion results of the conversion processing systems A, B and C will be referred to raster images A, B, and C, respectively.

The difference detection part 116 compares the raster images A, B, and C respectively outputted from the conversion processing systems A, B and C, then detects a significant difference existing thereamong and outputs difference information representing the detection result. The difference among the raster images to be detected is a difference of the color of the same pixel, a difference of the width or position of a figure (for example, a line) among the raster images, for example.

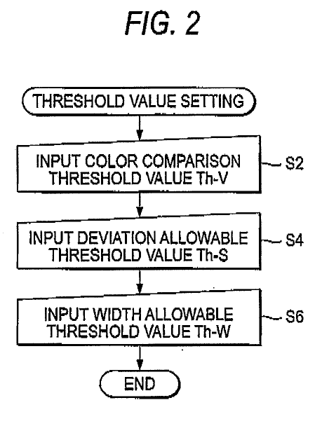

FIG. 2 shows a threshold value setting procedure for detecting the difference in the difference detection part 116. As shown in this procedure, a user sets a color comparison threshold value Th-V (S2), then sets a deviation allowable threshold value Th-S (S4) and sets a width allowable threshold value Th-W (S6) with respect to the image processing apparatus 100 of this embodiment. When a difference of the color of the same pixel among the raster images is within the color comparison threshold value Th-V, the color of the pixel is determined to be same among these raster images. The deviation allowable threshold value Th-S represents an allowable value of the positional deviation of the same figure among the raster images (that is, it is determined that there is no deviation when the positional deviation is within the allowable value). The width allowable threshold value Th-W represents an allowable value of the width at the position of the same figure among the raster images (that is, it is determined that the width is same when the difference of the width is within the allowable value). The order of setting the respective threshold values is not limited to the example shown in the figure. The image processing apparatus 100 provides a user interface screen for these setting operations. The user interface screen may be displayed on a display device attached to the image processing apparatus 100 or may be provided to a remote personal computer (PC) in a format of a web page, for example.

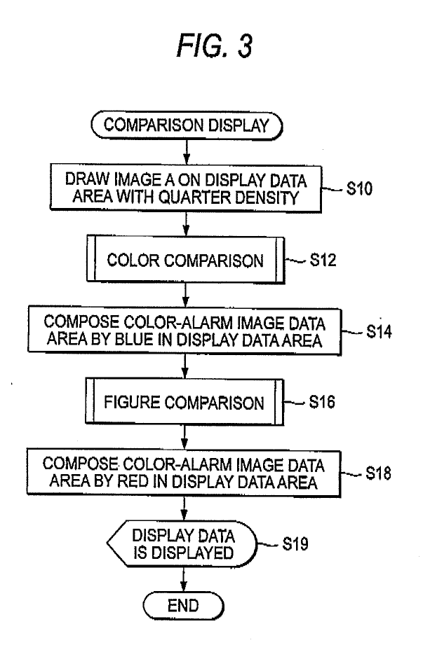

FIG. 3 shows an example of the entire processing procedure executed by the difference detection part 116. This figure shows a difference flow for comparing two raster images (provisionally called as an image A and an image B) to detect a difference therebetween.

According to this procedure, one of the two raster images is set as a reference image (the image A in the figure) and a difference of the other image with respect to the reference image is obtained and displayed. To this end, one of the conversion processing systems provided at the image processing apparatus 100 may be designated as the processing system for the reference image in advance.

According to this procedure, the difference detection part 116 firstly draws the image A as the reference on a display data area secured within the memory of the image processing apparatus 100 with a density reduced to a predetermined rate (for example, the density of a quarter of that of the original image) (S10). That is, in this case, the respective pixel values (values of cyan C, magenta M, yellow Y and black K in the case of a color image) of each of the pixels of the image A are reduced to the predetermined rate and an image thus reduced in its density is formed in the display data area.

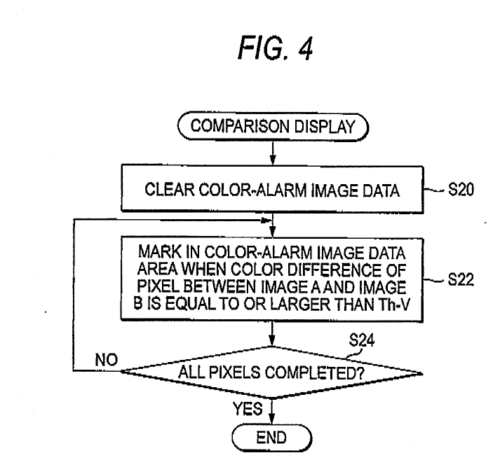

Next, the difference detection part 116 executes a color comparison processing (S12). The detailed procedure of the color comparison processing is shown in FIG. 4. In this processing, firstly a color-alarm image data area (which is secured in the memory by the difference detection part 116 in advance), for recording pixels each of which is determined to be different in color between the image A and the image B, is cleared (S20). The color-alarm image data area is an area which can store an image having the same pixel number as that of the image A and the image B supposing that one pixel is one bit. In this case, as to a pixel having the same color between the image A and the image B, a value of the corresponding pixel in the color-alarm image data area is set to be 0, for example. In contrast, as to a pixel having different colors between the image A and the image B, a value of the corresponding pixel in the color-alarm image data area is set to be 1, for example. In step S20, the values of the respective pixels in the color-alarm image data area are set to 0.

Next, the difference detection part 116 obtains a difference of color for each pixel between the image A and the image B, then compares the color difference thus obtained with the color comparison threshold value Th-V. When the color difference is equal to or larger than Th-V, this pixel is marked (recorded) in the color-alarm image data area (S22, S24). In this respect, for example, a distance in the CMYK space between the pixel values (CMYK values) of the corresponding pixels between the image A and the image B may be obtained as the color difference. In the marking processing, the pixel value in the color-alarm image data area is set to be 1, for example.

The aforesaid processings are repeated for all pixels. When the aforesaid processings are completed for all pixels, the process returns to the procedure of FIG. 3. Then, the difference detection part 116 composes an image of the color-alarm image data area by a predetermined color (for example, blue) for representing the pixels having the color difference, with respect to the display data area (S14).

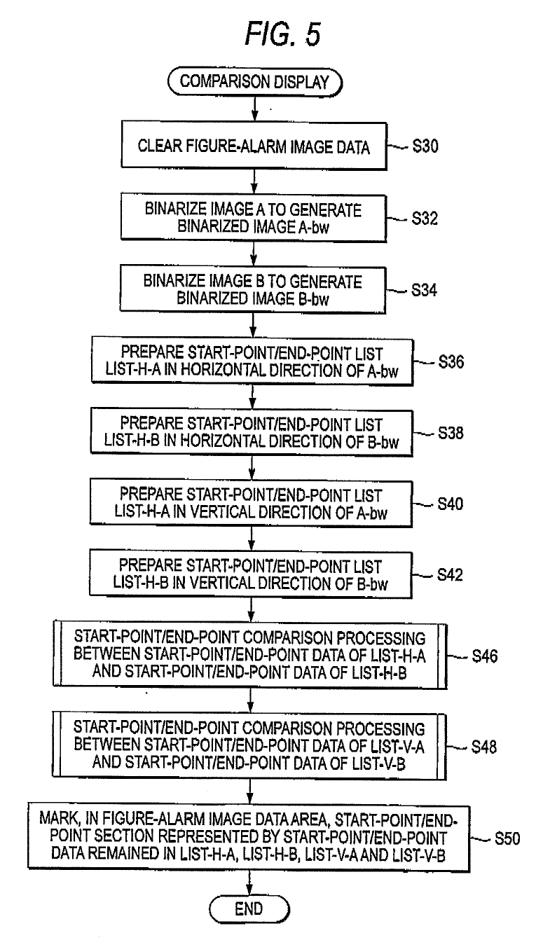

Next, the difference detection part 116 executes a figure comparison processing (S16). The detailed procedure of the figure comparison processing is shown in FIG. 5. In this processing, firstly, a figure-alarm image data area (which is secured in the memory by the difference detection part 116 in advance), for recording pixels each of which is determined to be different in figure between the image A and the image B, is cleared (S30). The figure-alarm image data area is an area which can store an image having the same pixel number as that of the image A and the image B supposing that one pixel is one bit. In this case, as to a pixel same in the figure between the image A and the image B, a value of the corresponding pixel in the figure-alarm image data area is set to 0, for example. In contrast, as to a pixel different in the figure between the image A and the image B, a value of the corresponding pixel in the color-alarm image data area is set to 1, for example. In step S30, the values of the respective pixels in the figure-alarm image data area are set to 0.

Next, the difference detection part 116 binarizes the image A to generate a binarized image A-bw (S32) and also binarizes the image B to generate a binarized image B-bw (S34). The processing order of steps S32 and S34 may be exchanged. In the binarizing processing, for example, the pixel value of a pixel which all color values of the original image are 0 (that is, C=M=Y=K=0) is set to 0, whilst the pixel value of a pixel which one of color values of the original image is not 0 is set to 1. Alternatively, in order to prevent the influence of the flat tint or halftone of the background, the pixel value may be set to 0 when C+M+Y+K is smaller than 128 and the pixel value may be set to 1 when C+M+Y+K is equal to or larger than 128 (supposing that each of C, M, Y, K is in a range of 0 to 255).

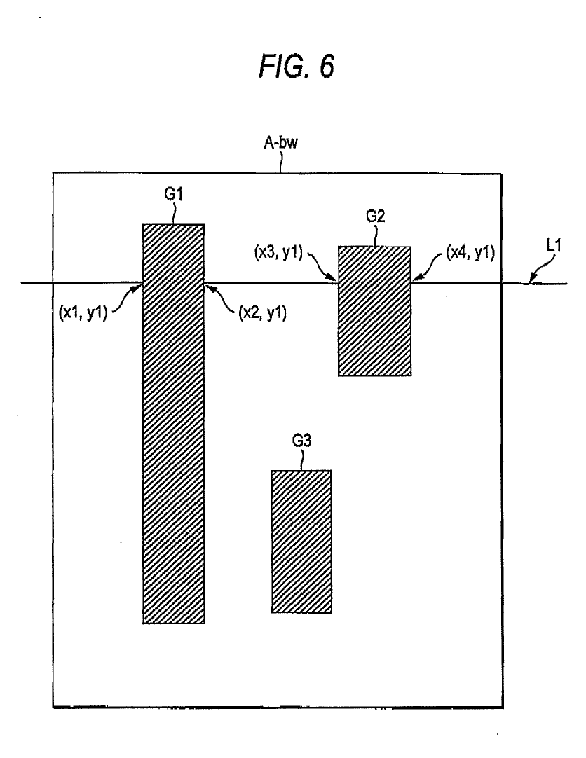

Next, the difference detection part 116 prepares a start-point/end-point list List-H-A in the horizontal direction of the binarized image A-bw (S36). The start-point/end-point list List-H-A is a list for storing respective pairs of the start-point coordinates and the end-point coordinates (hereinafter called start-point/end-point data) in the case where scanning lines in the horizontal direction cross each figure element (that is, a cluster of black pixels) on the binarized image A-bw. For example, the binarized image A-bw shown in FIG. 6 includes three figure elements G1, G2 and G3, for example. A scanning line L1 crosses with the figure element G1 between (x1, y1) and (x2, y1) and also crosses with the figure element G2 between (x3, y1) and (x4, y1). Thus, the two start-point/end-point data ((x1, y1), (x2, y1)) and ((x3, y1), (x4, y1)) are registered in the start-point/end-point list List-H-A with respect to the scanning line L1. In step S36, the scanning is made along each scanning line sequentially from the upper end of the binarized image A-bw to obtain a pair of the start-point and the end-point crossing with each of the figure elements for each scanning line to thereby store in the start-point/end-point list List-H-A. A plurality of the start-point/end-point data on the scanning line L1 is common as to the y-coordinate, that is, y1. Thus, the start-point/end-point list may store the x-coordinates of respective pairs of the start-point/end-point coordinates on a scanning line for each y-coordinate of the scanning lines. In this case, for example, in the aforesaid example, as to the scanning line L1, the two start-point/end-point data (x1, x2) and (x3, x4) in correspondence with y1 is registered in the start-point/end-point list.

Similarly, the difference detection part 116 prepares a start-point/end-point list List-H-B in the horizontal direction of the binarized image B-bw, a start-point/end-point list List-V-A in the vertical direction of the binarized image A-bw and a start-point/end-point list List-V-B in the vertical direction of the binarized image B-bw (S38, S40, S42). The execution order of steps S36 to S42 may be changed from the figure.

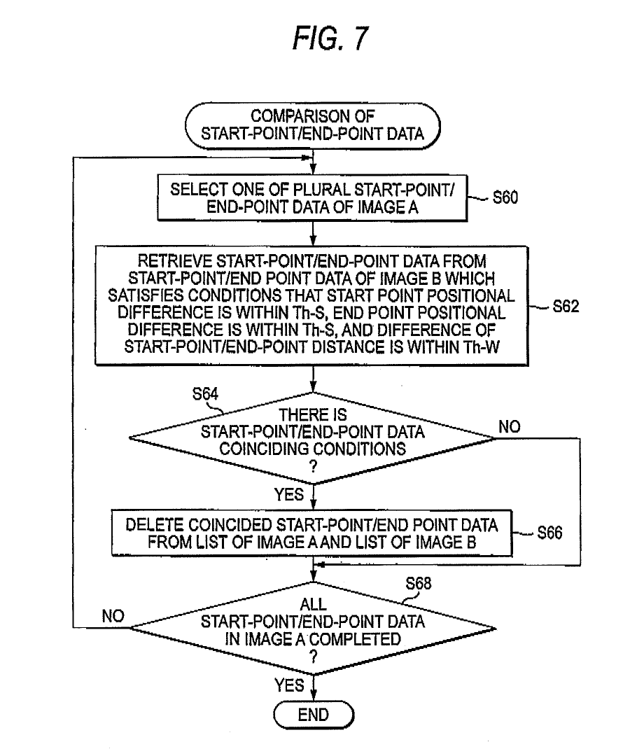

Next, the difference detection part 116 compares the start-point/end-point list List-H-A with the start-point/end-point list List-H-B in the horizontal direction (S46). An example of the procedure of the comparison processing is shown in FIG. 7.

According to the procedure shown in FIG. 7, one of the plural start-point/end-point data is selected from the list of the image A as the reference image (the List-H-A in this case) (S60). In this case, for example, the start-point/end-point data may be selected in the order of the raster scanning, that is, from the upper side to the lower side and from the left side to the right side. In the case of preparing the list, if the plural start-point/end-point data is collected in such the order and registered in the list, the start-point/end-point data may be selected in the order from the head portion of the list.

Next, the difference detection part 116 retrieves start-point/end-point data from the list of the image B (the List-H-B in this case) which satisfies conditions that each of the difference of the start point coordinate (distance) from the start-point/end-point data selected in step S40 and the difference of the end point coordinate therefrom is within the threshold value Th-S, and the difference between the distance between the end point and the start point of the data in the List-H-B and the distance between the end point and the start point in the start-point/end-point data selected in step S40 is within the threshold value Th-W (S62). In this retrieval, an area to be retrieved may be limited to the start-point/end-point data group corresponding to the same horizontal scanning line (that is, the same y coordinate) as the start-point/end-point data selected in step S60. Then, it is determined whether or not the start-point/end-point data satisfying the retrieval conditions of step S62 is found from the list of the image B (S64). When such the start-point/end-point data is found, the start-point/end-point data thus selected or retrieved is deleted from the respective lists of the image A and the image B (S68). When the start-point/end-point data satisfying the retrieval conditions is not found, the processing of step S66 is skipped.

Then, the processings of steps S60 to S66 are repeatedly executed for all the start-point/end-point data in the list of the image A (S68). According to the aforesaid processings, in each of the lists of the image A and the image B, there remains only start-point/end-point data each of which does not coincide with the data of the partner-side list within the allowable range.

As described above, although the explanation is made as to the comparison between the start-point/end-point lists List-H-A and List-H-B in the horizontal direction, the difference detection part 116 executes the comparison processing shown in FIG. 7 as an example also as to the start-point/end-point lists List-V-A and List-V-B in the vertical direction (S48). The execution order of steps S46 and S48 may be changed.

Then, the difference detection part 116 marks, in the figure-alarm image data area, the start-point/end-point section represented by each of the start-point/end-point data remained in the start-point/end-point lists List-H-A, List-H-B, List-V-A and List-V-B having been subjected to the processings of steps S46 and S48 (S50). In the marking processing, each of the pixel values in the start-point/end-point section represented by the start-point/end-point data in the figure-alarm image data area may be set to 1.

When the processing of step S50 is completed, the process returns to the processing of FIG. 3. Then, the difference detection part 116 composes an image of the figure-alarm image data area by a predetermined color (color different from the cooler representing the color difference, for example, red) for representing the pixels having the deviation or width difference in the figure, with respect to the display data area (S18). Then, the image of the figure-alarm image data area as the result of the composition is presented to a user (S19). The presentation may be performed with respect to the display device attached to the image processing apparatus 100 or to a remote PC used by a user as a display screen for a web page.

In the processing of FIG. 3, the pair of steps S12 and S14 and the pair of steps S16 and S18 may be altered in the execution order.

As described above, the explanation is made as to the processing of detecting and presenting the different portions between the output raster images of the two conversion processing systems. In the case of comparing the output raster images of the three or more conversion processing systems, the comparison between the reference raster image and each of the remaining raster images is performed in accordance with the procedure of FIG. 3, and the display data as the respective comparison results may be superimposed and displayed. In this case, the display color of the different portions between the reference image and the remaining raster image maybe differentiated between the respective remaining raster images.

In the aforesaid example, although the different portion between the output raster images of the conversion processing systems is displayed as an image, the presentation method of the different portion is not limited thereto. For example, alternatively, a message representing whether or not there is the different portion may be displayed.

When a difference between the images of the conversion processing systems is detected by the image processing apparatus 100, a user who inspected PDF data by using the image processing apparatus 100 corrects the PDF data, for example. In the correction, for example, another PDF data may be prepared by using another PDF generation tool based on application data from which the PDF data is generated. Alternatively, the application data may be corrected as to the different portion thus detected or the different portion may be converted into a raster image and then disposed in the raster image, and then PDF data may be generated again.

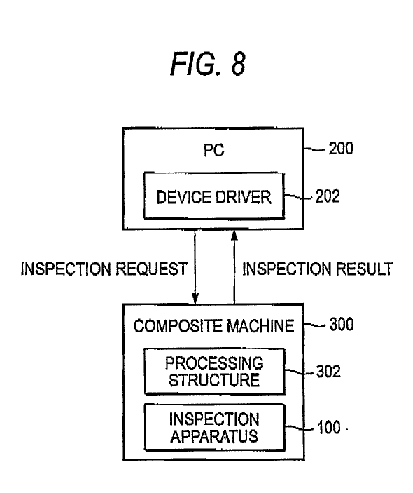

The image processing apparatus (inspection apparatus) 100 explained above can be realized by installing a single program or a set of plural programs for realizing the function of the image processing apparatus 100 into a PC used by a user, for example. As another example, as shown in FIG. 8, the image processing apparatus (inspection apparatus) 100 may be incorporated into a composite machine (apparatus having functions of a network printer, a network scanner, and a copying machine etc.) 300. The composite machine 300 includes the function of the image processing apparatus (inspection apparatus) 100 as well as a processing structure 302 for printing and scanning processings etc. The composite machine 300 provides an interface for using the function of the inspection apparatus 100 with respect to an external device. A user PC 200 includes a program for calling the interface. For example, such the program is contained in a device driver 202 for the composite machine 300. In this case, a user designates PDF data to be processed and also designates “inspection” as the processing for the designated PDF data on the user interface screen of the device driver 202. According to these designations, an inspection request is transmitted to the composite machine 300 together with the PDF data. The inspection request is processed by the inspection apparatus 100 within the composite machine 300, whereby information representing the presence/non-presence of a difference between images of the conversion processing systems or display data representing a different portion each obtained by the processing is sent to the PC200 as a result of the inspection. The device driver 202 displays the inspection result.

FIG. 1 shows, as an example, the conversion processing systems A, B and C which differ thereamong in the conversion program or the combination of the conversion programs for converting PDF data into a raster image. However, the embodiment is not limited thereto, and the image processing apparatus (inspection apparatus) 100 may includes a plurality of the conversion processing systems which contain different versions of the same conversion program, respectively. In this case, the same processing can be performed as the aforesaid example.

One of the conversion programs may be arranged to change a part of the contents of the drawing processing in accordance with an amount of the memory capable of being used. In this case, the image processing apparatus (inspection apparatus) 100 may include a conversion processing system which is arranged to use the same conversion program but to differentiate memory amounts allocated to the program as a work area in plural stages.

Some of the conversion programs may be arranged to change the setting of the operation mode such as the operation of font cache, the adjustment of the position and the thickness of a fine-line etc. In this case, the image processing apparatus (inspection apparatus) 100 may include a conversion processing system which is arranged to use the same conversion program but to differentiate the setting of the operation mode of the program.

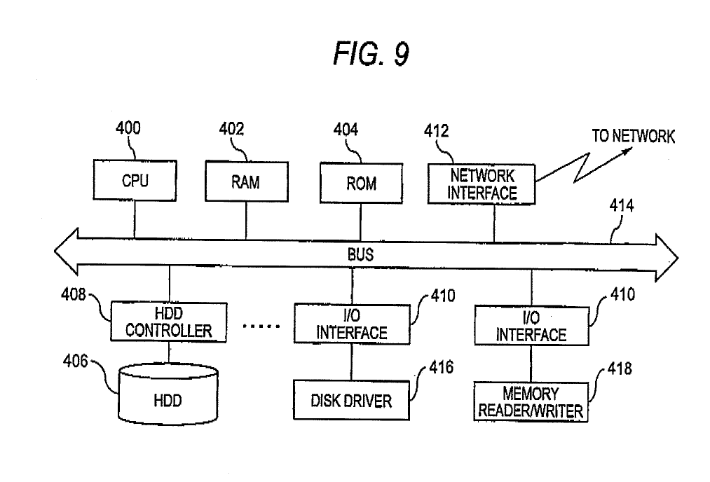

The image processing apparatus (inspection apparatus) 100 explained above can be realized by rendering a general purpose computer to execute the programs representing the processings of the aforesaid respective functional modules, for example. The computer includes as a hardware, as shown in FIG. 9, a circuit configuration which has a microprocessor such as a CPU 400, memories (primary storage) such as a random access memory (RAM) 402 and a read only memory (ROM) 404, an HDD controller 408 for controlling an HDD (hard disk driver) 406, various kinds of I/O (input/output) interfaces 410, a network interface 412 for performing the control for the connection with a network such as a local area network etc., that are coupled from one another via a bus 414, for example. Further, fore example, a disk drive 416 for performing a reading and/or writing operation with respect to a portable disk type recording medium such as a CD or a DVD and a memory reader/writer 418 for performing a reading and/or writing operation with respect to a portable nonvolatile type recording medium of various kinds of standards such as a flash memory may be coupled to the bus 414 via the I/O interface 410. The programs describing the processing contents of the aforesaid respective functional modules shown as an example is stored in a fixed storage device such as a hard disk drive via a recording medium such as a CD or a DVD or via a communication means such as a network and then installed into the computer. When the programs stored in the fixed storage device are read by the RAM 402 and executed by the microprocessor such as the CPU 400, the aforesaid functional module group is realized. A part or all of the functional module group may be configured as a hardware circuit such as a dedicated LSI (Large Scale Integration), an ASIC (Application Specific Integrated Circuit) or an FPGA (Field Programmable Gate Array).

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image processing apparatus comprising:
a conversion control unit that controls each of a plurality of different conversion processing systems, which converts page description language data into raster image data, to convert page description language data to be inspected into raster image data; and
a difference information outputting unit that outputs difference information in a case where there is a difference among the raster image data as conversion results obtained by the conversion processing systems.

2. The image processing apparatus as claimed in claim 1, wherein
the difference information outputting unit outputs a difference image which represents, in a different display format, a pixel being different among the raster image data as the conversion results and a pixel having no difference among the raster image data as the conversion results.

3. The image processing apparatus as claimed in claim 1, wherein
the conversion control unit renders at least one of the conversion processing systems to convert the page description language data to be inspected under a plurality of conditions different in a memory amount capable of being used.

4. The image processing apparatus as claimed in claim 1, wherein
the conversion control unit renders at least one of the conversion processing systems to convert the page description language data which is under a plurality of conditions different in setting of an operation mode of the at least one of the conversion processing systems.

5. The image processing apparatus as claimed in claim 1, wherein
the difference among the raster image data is a difference of the color of the same pixel, a difference of the width or position of a figure among the raster image data.

6. An image processing method comprising:
controlling each of a plurality of different conversion processing systems, which converts page description language data into raster image data, to convert page description language data to be inspected into raster image data; and
outputting difference information in a case where there is a difference among the raster image data as conversion results obtained by the conversion processing systems.

7. A computer readable medium storing a program causing a computer to execute a process for performing image processing, the process comprising:
controlling each of a plurality of different conversion processing systems, which converts page description language data into raster image data, to convert page description language data to be inspected into raster image data; and
outputting difference information in a case where there is a difference among the raster image data as conversion results obtained by the conversion processing systems.
